(19) United States
(12) Patent Application Publication
(10) Pub. No.: US 2014/0152715 A1
(43) Pub. Date: Jun. 5, 2014

(54) FRAME RATE CONVERTER AND TIMING CONTROLLER AND PROCESSING APPARATUS AND METHOD THEREOF

(71) Applicant: HIMAX MEDIA SOLUTIONS, INC., Tainan City (TW)

(72) Inventor: Shan-Chieh Wen, Tainan City (TW)

(73) Assignee: HIMAX MEDIA SOLUTIONS, INC., Tainan City (TW)

(21) Appl. No.: 13/691,836

(22) Filed: Dec. 2, 2012

(51) Int. Cl. G09G 5/02

(52) U.S. Cl. CPC G09G 5/02
USPC 345/691; 345/690

(57) ABSTRACT

A frame rate converter includes: a receiving circuit for receiving an input image data and accordingly outputting an output image data, the input image data having a plurality of data segments with information of a plurality of color components of pixels of a frame, respectively, wherein each of the data segments includes information of a same color component only; a frame buffer for storing the output image data; and a first multiplexer for selecting one of the output image data outputted from the receiving circuit and the output image data buffered in the frame buffer as an output of the frame rate converter. The first multiplexer outputs the output image data buffered in the frame buffer at least once after outputting the output image data outputted from the receiving circuit to generate at least one duplication of the frame.

### BACKGROUND OF THE INVENTION

1. Field of the Invention

The present invention relates generally to frame rate conversion, and more particularly to, a frame rate converter, a timing controller, a processing apparatus, and related method for a low-latency frame rate conversion.

2. Description of the Prior Art

Liquid crystal-based displays, such as liquid crystal based display (LCD) or Liquid crystal on silicon (LCoS) are notoriously known to have motion blur due to the slow response and sample-hold characteristics of liquid crystals. To alleviate the motion blur, improving the LC response is one of possible solutions. However, if the response time is shortened, there must be more frames generated to refresh the display device. Frame rate conversion is a technique used to generate more insertion frames. These additional insertion frames will be inserted between original consecutive frames.

There are several common ways of generating insertion frames, such as motion compensation/motion estimation, black frame insertion, and frame duplication. In the case of frame duplication, a duplication of a previous frame will be created and then inserted between the previous frame and a following frame. Due to duplication of image data of the previous frame, frame delay is therefore generated. FIG. 1 illustrates how frame delay occurs in the duplication of the frame. As shown in FIG. 1, an original frame sequence at 60 Hz is inputted for frame rate conversion. With duplication of inputted frames, a frame sequence at 120 Hz is outputted to a display terminal. The display terminal will start the displaying of Frame I after a frame period (i.e., 1/60 second). This delay is unfavorable for some applications, such as video gaming. Therefore, there is a need to ameliorate the frame delay caused by the frame rate conversion.

### SUMMARY OF THE INVENTION

With this in mind, it is one objective of the present invention to provide a frame rate conversion technique which causes less frame delay compared to the conventional art. In the present invention, color sequential displaying method is used in conjunction with an image data rearrangement technique.

A first aspect of embodiments of the present invention provides a frame rate converter. The frame rate converter comprises: a receiving circuit, a frame buffer and a first multiplexer. The receiving circuit is utilized for receiving an input image data and accordingly outputting an output image data, the input image data having a plurality of data segments with information of a plurality of color components of pixels of a frame, respectively, wherein each of the data segments includes information of a same color component only. The frame buffer is coupled to the receiving circuit and utilized for storing the output image data. The first multiplexer is coupled to the frame buffer and the receiving circuit, and utilized for selecting one of the output image data outputted from the receiving circuit and the output image data buffered in the frame buffer as an output of the frame rate converter. Additionally, the first multiplexer outputs the output image data buffered in the frame buffer at least once after outputting the output image data outputted from the receiving circuit to generate at least one duplication of the frame.

A second aspect of embodiments of the present invention provides a frame rate converter for stereoscopic display. The frame rate converter comprises a receiving circuit and a buffer module. The receiving circuit is utilized for receiving a left-view input image data and a right-view input image data, and accordingly outputting a left-view output image data and a right-view output image data, each of the left-view input image data and the right-view input image data comprising a plurality of data segments with information of a plurality of color components of pixels of an interleaved frame, respectively, wherein each of the data segments includes information of a same color component only. The buffer module comprises a first frame buffer and a second frame buffer. The first frame buffer is coupled to the receiving circuit, and utilized for storing the left-view output image data. The second frame buffer is coupled to the receiving circuit, and utilized for storing the right-view output image data. The first frame buffer outputs the left-view output image data buffered therein more than once, and the second frame buffer outputs the right-view output image data buffered therein more than once to generate at least one duplication of each interleaved frame.

A third aspect of embodiments of the present invention provides a timing controller. The timing controller comprises: a receiving circuit, a frame buffer, a first multiplexer and a backlight source controlling circuit. The receiving circuit is utilized for receiving an input image data and accordingly outputting an output image data, the input image data having a plurality of data segments with information of a plurality of color components of pixels of a frame, respectively, wherein each of the data segments includes information of a same color component only. The frame buffer is coupled to the receiving circuit, and utilized for storing the output image data. A first multiplexer is coupled to the frame buffer and the receiving circuit, and utilized for selecting one of the output image data outputted from the receiving circuit and the output image data buffered in the frame buffer as an output of the frame rate converter. The backlight source controlling circuit is utilized for controlling operating timing of a plurality of backlight sources in response to a plurality of color component identifiers respectively corresponding to each data segment. The first multiplexer outputs the output image data buffered in the frame buffer at least once after outputting the output image data outputted from the receiving circuit to generate at least one duplication of the frame.

A fourth aspect of embodiments of the present invention provides a timing controller for stereoscopic displaying. The timing controller comprises a receiving circuit, a buffer module and a backlight source controlling circuit. The receiving circuit is utilized for receiving a left-view input image data and a right-view input image data, and outputting a left-view output image data and a right-view output image data, each of the left-view input image data and the right-view input image data comprising a plurality of data segments with information of a plurality of color components of pixels of an interleaved frame, respectively, wherein each of the data segments includes information of a same color component only. The buffer module comprises a first frame buffer and a second frame buffer. The first frame buffer is coupled to the receiving circuit, and utilized for storing the left-view output image data. The second frame buffer is coupled to the receiving circuit, and utilized for storing the right-view output image data. The backlight source controlling circuit is utilized for controlling operating timing of a plurality of backlight sources in response to a plurality of color component identifiers respectively corresponding to each data segment. The first frame buffer outputs the left-view output image data buffered therein more than once, and the second frame buffer outputs the right-view output image data buffered therein more than once to generate at least one duplication of each interleaved frame.

A fifth aspect of embodiments of the present invention provides a method of rearranging image data. The method comprises: successively receiving data of a plurality of pixels of a frame, wherein data of each of the pixels includes information of a plurality color components; and rearranging the data of each of the pixels of the frame to generate a plurality of data segments, wherein the data segments include information of the color components of the pixels, respectively, and each of the data segments includes information of a same color component only.

A sixth aspect of embodiments of the present invention provides a processing apparatus of rearranging image data. The processing apparatus comprises: a receiving unit and a rearranging unit. The receiving unit is utilized for successively receiving data of a plurality of pixels of a frame, wherein data of each of the pixels includes information of a plurality color components. The rearranging unit is utilized for rearranging the data of each of the pixels of the frame to generate a plurality of data segments, wherein the data segments include information of the color components of the pixels, respectively, and each of the data segments includes information of a same color component only.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates frame delay caused by the frame rate conversion in the conventional art.

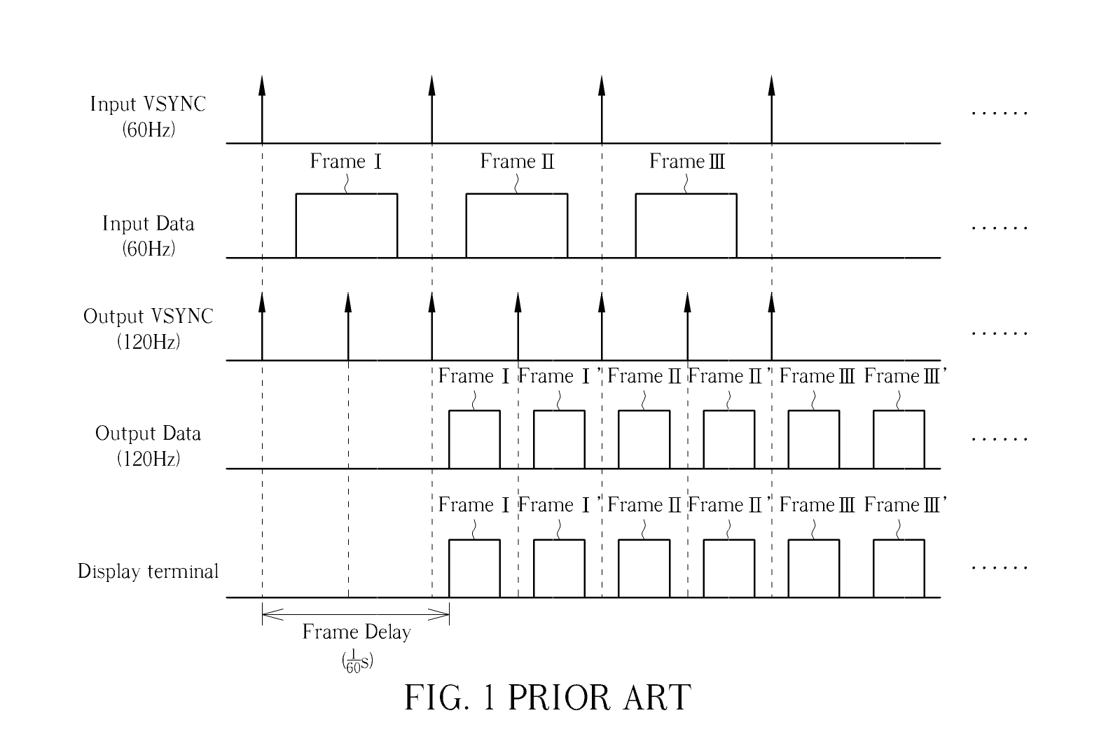

FIG. 2 illustrates arrangement of an image data in the conventional art.

FIG. 3 illustrates arrangement of an image data according to one exemplary embodiment of the present invention.

FIG. 4 illustrates how the present invention ameliorates the frame delay caused by the frame rate conversion.

FIG. 5 illustrates a flow chart of an image data rearrangement method according to one exemplary embodiment of the present invention.

FIG. 6 illustrates a block diagram of a processing apparatus for rearranging an image data according to one exemplary embodiment of the present invention.

FIG. 7 illustrates a block diagram of a frame rate converter according to one exemplary embodiment of the present invention.

FIG. 8 illustrates a block diagram of a timing controller according to one exemplary embodiment of the present invention.

FIG. 9 illustrates a block diagram of a frame rate converter for stereoscopic displaying according to one exemplary embodiment of the present invention.

FIG. 10 illustrates a block diagram of a timing controller for stereoscopic displaying according to one exemplary embodiment of the present invention.

### DETAILED DESCRIPTION

Certain terms are used throughout the following descriptions and claims to refer to particular system components. As one skilled in the art will appreciate, manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

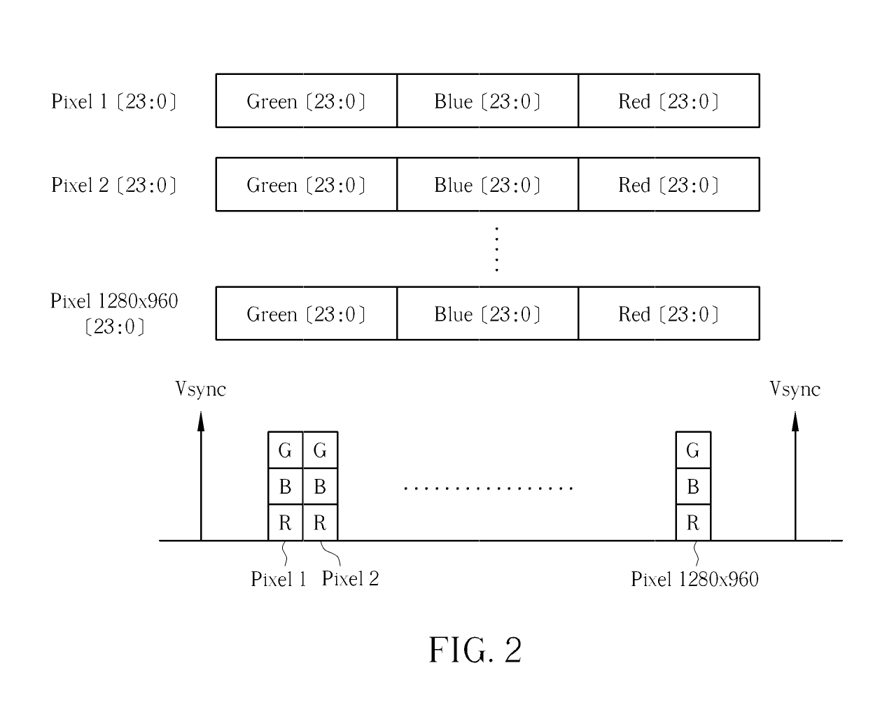

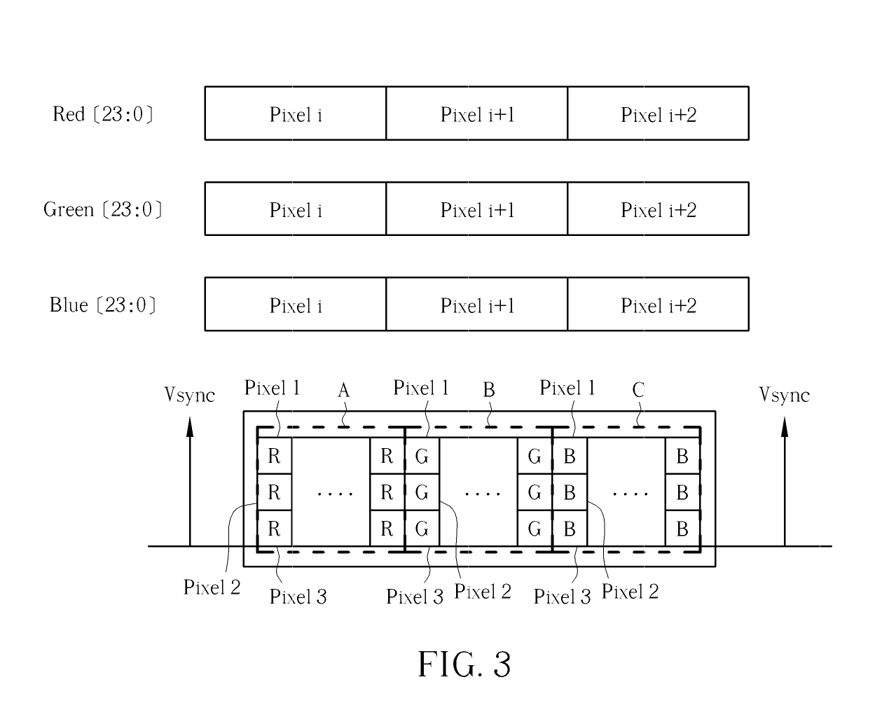

In order to ameliorate the frame delay caused by the frame rate conversion, the present invention utilizes image data rearrangement method and color sequential displaying method. The illustration of the image data rearrangement method is shown FIG. 2 and FIG. 3. Please refer to FIG. 2, which illustrates traditional arrangement of a pixel data and transmission timing chart. The pixel data shown in FIG. 2 comprises information of color components Red, Green, and Blue, each of 8 bits. Supposed that a whole image has 1280×960 pixels and is indented to be displayed within a frame period (e.g. 1/60 second), the image data will be transmitted in the manner as shown in FIG. 2. Each transmission a 24-bit long color code including 8-bit Red color information, and 8-bit Blue color information and 8-bit Green color information of a same pixel is transmitted. In the present invention, the image data shown in FIG. 2 will be rearranged into a form as shown in FIG. 3. The rearranged image data includes data segments A, B and C. Each of the data segments A, B, and C includes information of a same color component only. For example, data segment A includes information of Red color component only, the data segment B includes information of Green color component only and the data segment C includes information of Blue color component only. In addition, each data segment includes information of the same color component of all the pixels. For example, the data segment A includes information of Red color component of pixels 1−(1280×960), and so does the data segment B and data segment C. In this arrangement, each transmission a 24-bit long color code including information of a same color of successive pixels is transmitted. For example, information of Red color component of pixel i, pixel i+1, and pixel i+2 will be transmitted during one transmission. Therefore, adjacent pixels in a same row of the frame are contiguously arranged in a same data segment.

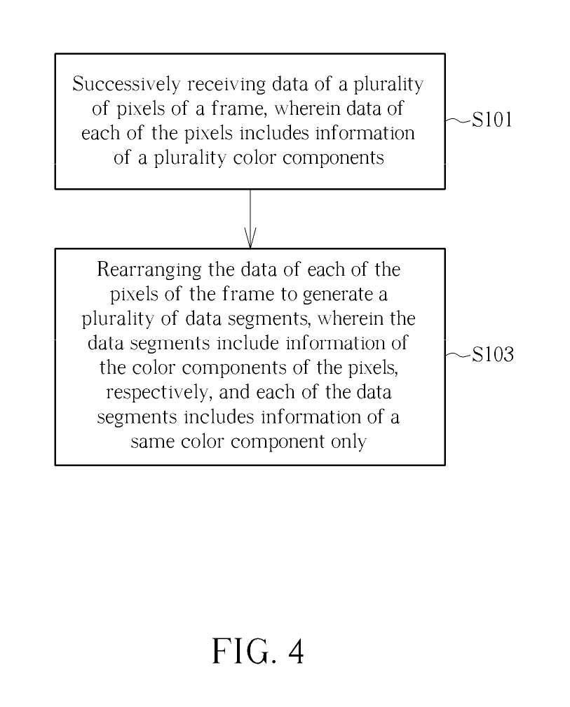

The method of rearranging the image data as shown in FIG. 2 into a rearranged image data shown in FIG. 3 is illustrated with a flow chart shown in FIG. 4. Please refer to FIG. 4. In step S101, the data of a plurality pixels of a frame (i.e. image data shown in FIG. 2) is successively received. Then, the flow goes to step S103, where the data of each of the pixels of the frame is rearranged to generate a plurality of data segments A, B, C as shown in FIG. 3, wherein the data segments include information of the color components of the pixels, respectively, and each of the data segments includes information of a same color component only. Based on the method illustrated in FIG. 4, the present invention further provides a processing apparatus of rearranging image data.

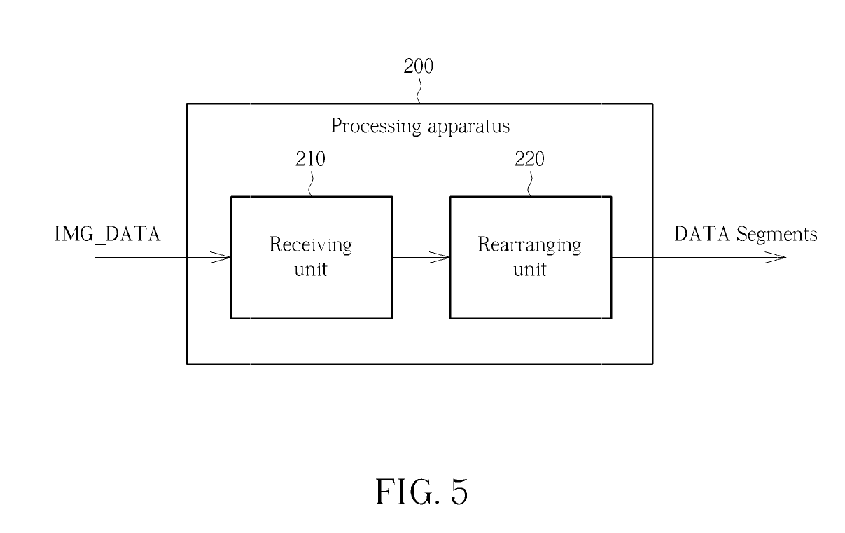

Please refer to FIG. 5, which schematically illustrates a block diagram of a processing apparatus according to one exemplary embodiment of the present invention. As shown, processing apparatus 200 is used to rearranging an image data IMG_DATA. The processing apparatus 200 includes a receiving unit 210 and a rearranging unit 220. The receiving unit 210 is utilized for successively receiving data of pixels of a frame contained in the image data IMG_DATA. The rearranging unit 220 is coupled to the receiving circuit 210, and utilized for rearranging the data of each of the pixels of the frame to generate a plurality of data segments, wherein the data segments include information of the color components of the pixels, respectively, and each of the data segments includes information of a same color component only.

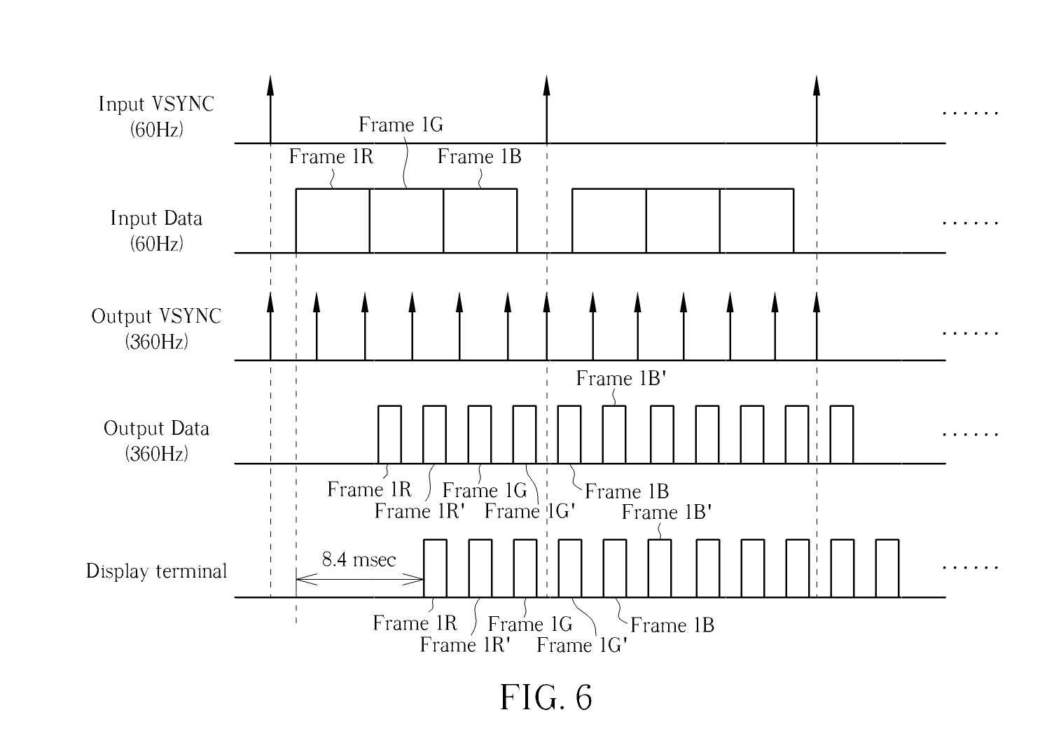

The frame delay caused by the frame rate conversion can be ameliorated by using the inventive image data rearrangement method and the color sequential displaying method. The reason will be apparent from the following description and FIG. 6. A color sequential displaying system allows a display terminal to start image scanning once a color-sequential frame corresponding to one color component is received. For example, once a color-sequential frame corresponding to color component Red is received by the display terminal, the display terminal will start the displaying of the received frame. If the color sequential displaying system is combined with the above-mentioned image data rearrangement method, the frame delay caused by frame rate conversion can be greatly ameliorated. This is because the above-mentioned image data rearrangement method arranges data of a same color component of all pixels contiguously. When the data segment A corresponding to Red color component is generated and transmitted to the display terminal, the display terminal can immediately start to display without waiting for transmission of other data segments since the data segment A is substantially identical to data of a color-sequential frame corresponding to Red color component. Referring to FIG. 6, the frame rate conversion sequentially outputs Frame 1R, Frame 1R′, Frame 1G, Frame 1G′, Frame 1B, and Frame 1B′, wherein Frame 1R′, 1G′, 1B′ is a duplication of Frame 1R, 1G, 1B respectively. Accordingly, the display terminal sequentially displays Frame 1R, 1R′, 1G, 1G′, 1B and 1B′. Combining the inventive rearrangement method, the data segment A can be used as Frame 1R of the input data shown in FIG. 6 while the data segment B can be used as Frame 1G, and the data segment C can be used as Frame 1B. As a result, the frame rate conversion can be achieved by simply duplicating the data segment A, B and C. Referring back to FIG. 6 the frame delay according to the present invention is reduced to one thirds of a frame period ( 1/180 second). Compared to this, the prior-art display terminal will not start the displaying of Frame I until all the data of Frame I is received. Therefore, the conventional art has a frame delay of one frame period ( 1/60 second). The present invention significantly reduces the frame delay caused by the frame rate conversion.

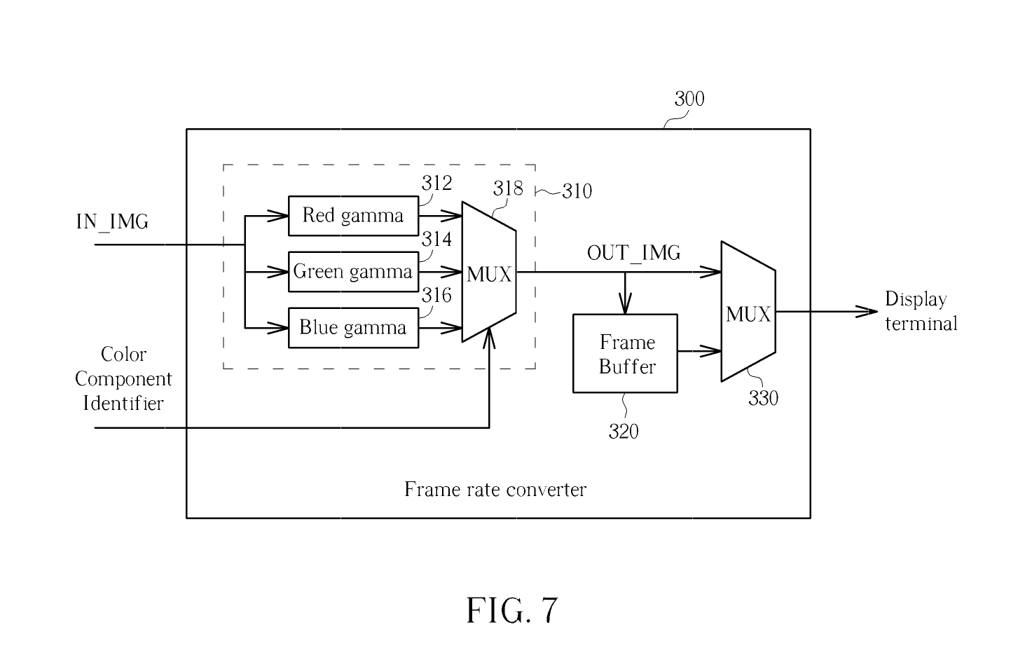

Based on the abovementioned image data rearrangement method, the present invention further provides a frame rate converter. With reference to FIG. 7, a block diagram of a frame rate converter is illustrated according to one exemplary embodiment of the present invention. Frame rate converter 300 includes a receiving circuit 310, a frame buffer 320, and a first multiplexer 330. The receiving circuit 310 is utilized for receiving an input image data IN_IMG and accordingly outputting an output image data OUT_IMG. The input image data IN_IMG is substantially identical to the rearrangement image data as shown in FIG. 3, which includes a plurality of data segments (e.g. data segment A, data segment B, and data segment C). Each of the data segments of input image data IN_IMG includes information of a same color component only. The output image data OUT_IMG corresponds to one of the data segments A, B and C. The frame buffer 320 is coupled to the receiving circuit 310 for storing the output image data OUT_IMG. The first multiplexer 330 is coupled to the frame buffer 320 and the receiving circuit 310, and utilized for selecting one of the output image data OUT_IMG outputted from the receiving circuit 310 and the output image data OUT_IMG buffered in the frame buffer 320 as an output of the frame rate converter 300. Detailed operations of the frame rate converter 300 are explained as below.

At first, an image data comprising data segments A, B, and C is sequentially inputted (each time 24-bit long color code is inputted) to the frame converter 300, the first multiplexer 330 selects the output image OUT_IMG of the receiving circuit 310 as the output (i.e., Frame 1R), wherein the output image OUT_IMG is one of data segments A, B, and C. Also, the output image OUT_IMG is stored in the frame buffer 320. Once the output image OUT_IMG of the receiving circuit 310 has been completely sent to the display terminal. The frame buffer 320 then continues to store a next data segment (i.e., Frame 1G) and the first multiplexer 330 outputs data buffered in the frame buffer 320 to generate a duplication of the frame (i.e., Frame 1R′). Please note that the first multiplexer 330 may outputs the output image data OUT_IMG buffered in the frame buffer 320 more than once to generate more insertion frames.

In one embodiment, the receiving circuit 310 further comprises a plurality of gamma conversion units 312-316 and a second multiplexer 318. The gamma conversion units 312-316 perform gamma conversions on the data segments of the input image data IN_IMG. Each of gamma conversion units 312-316 will perform a gamma conversion corresponding to a specific color on the data segments A, B, and C. For example, the Red gamma conversion unit 312 will perform gamma conversion on the data segment A. The second multiplexer 318 is coupled to the gamma conversion units 312-316, and operates in response to a plurality of color component identifiers respectively corresponding to the data segments. Each data segment corresponds to a specific color component identifier. The second multiplexer 318 will multiplex outputs of the gamma conversion units 312-316 to generate the output image data OUT_IMG.

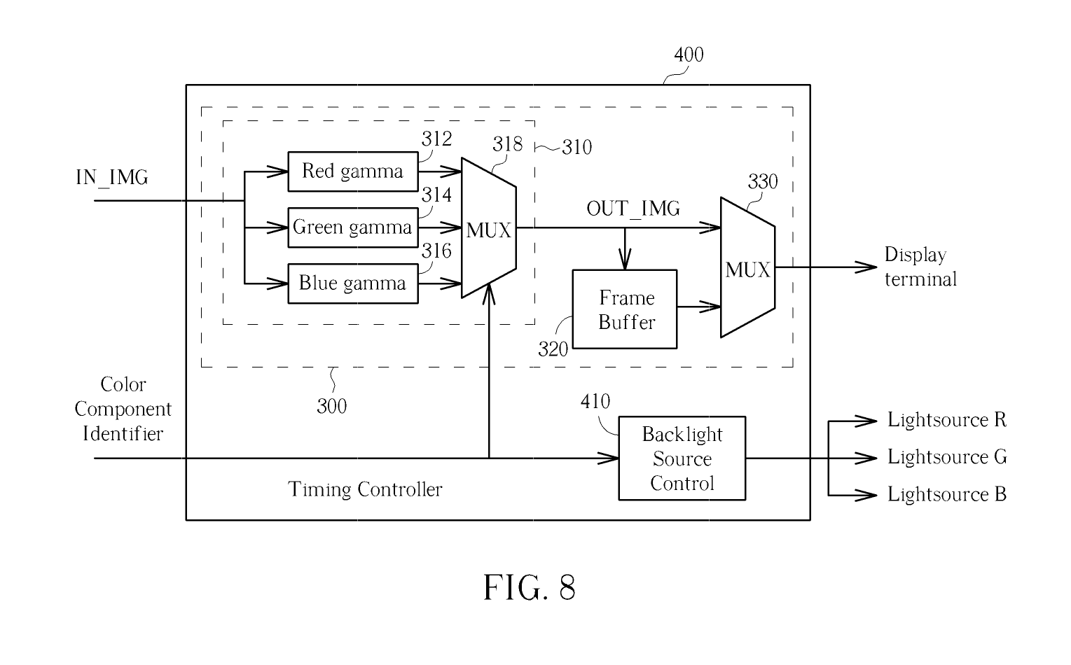

According to one exemplary embodiment, the present invention further provides a timing controller including the above-mentioned frame rate converter. With reference to FIG. 8, a block diagram of a timing controller is illustrated. The timing controller 400 includes a backlight source controlling circuit 410 and a frame rate converter 300 as explained above. The operations of the frame rate converter 300 have been thoroughly explained before, and more detailed descriptions are therefore omitted here for the sake of brevity. The backlight source controlling circuit 410 is utilized for controlling operating timing of a plurality of backlight sources in a display terminal in response to a plurality of color component identifiers corresponding to data segment A, B, and C. For example, when the first multiplexer 330 outputs the data segment A, the backlight source controlling circuit 410 will receive a Red color component identifier and therefore activate a backlight source R by sending a control signal to the display terminal. The timing controller 400 can not only control the operating timing of the backlight sources in the display terminal but also provides insertion frame to the display terminal with low frame delay.

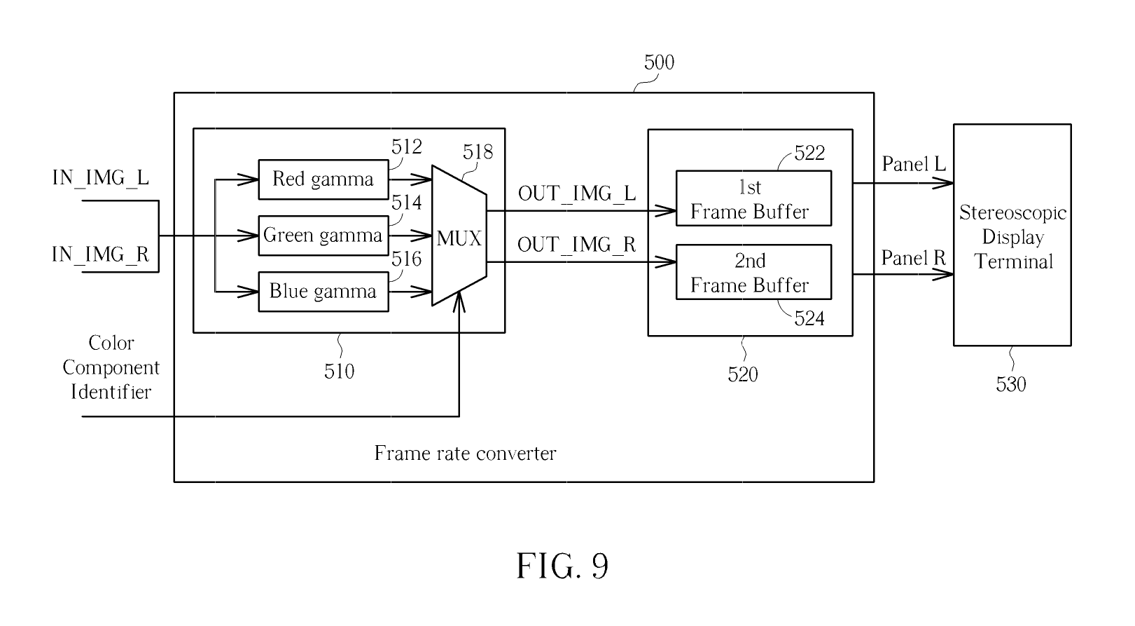

The present invention also provides a frame rate converter for stereoscopic display. With reference to FIG. 9, a block diagram of a frame rate converter for stereoscopic display is illustrated according to one exemplary embodiment of the present invention. As shown, frame rate converter 500 used for provides insertion frames for a stereoscopic display terminal. The stereoscopic display terminal includes a right-view panel R and a left view-panel L. The frame rate converter 500 includes a receiving circuit 510, a buffer module 520. The receiving circuit 510 is utilized for receiving a left-view input image data IN_IMG_L and a right-view input image data IN_IMG_R, each of which is an interleaved frame, and accordingly outputting a left-view output image data OUT_IMG_L and a right-view output image data OUT_IMG_R. The arrangement of each of the left-view input image data IN_IMG_L and the right-view input image data IN_IMG_R is substantially identical to the arrangement of the rearranged image data as shown in FIG. 3, which respectively includes a plurality of data segments (e.g. data segment A, data segment B, and data segment C). Each of the data segments of the left-view input image data IN_IMG_L and the right-view input image data IN_IMG_R includes information of a same color component only. The frame buffer 520 further includes a first frame buffer 522 and a second frame buffer 524. The first frame buffer 522 is utilized for storing the left-view output image data OUT_IMG_L. The second frame buffer 524 is utilized for storing the right-view output image data OUT_IMG_R. The first frame buffer 522 outputs the left-view output image data OUT_IMG_L buffered therein more than once, and the second frame buffer outputs the right-view output image data buffered IMG_R therein more than once to generate at least one duplication of each interleaved frame.

In this embodiment, the duplication of each interleaved frame (e.g. left-view image or right-view image) are performed by the first frame buffer 522 and the second frame buffer 524, respectively. The output of the receiving circuit 510 will not be directly provided to the stereoscopic display terminal 530, and it must be buffered in the first frame buffer 522 and the second frame buffer 524 at first. Then, the duplication of each interleaved frame is generated from the outputs of the first frame buffer 522 and the second frame buffer 524.

Similarly, the receiving circuit 510 comprises a plurality of gamma conversion units 512-516 and a multiplexer 518. The gamma conversion units 512-516 perform gamma conversions on the data segments of the input image data IN_IMG_L and IN_IMG_R. Each of gamma conversion units 512-516 will perform a gamma conversion corresponding to a specific color on the image data IN_IMG_L and IN_IMG_R. The multiplexer 518 is coupled to the gamma conversion units 512-516, and operates in response to a plurality of color component identifiers respectively corresponding to the image data IN_IMG_L and IN_IMG_R. The multiplexer 518 will multiplex outputs of the gamma conversion units 512-516 to generate the output image data OUT_IMG_L and OUT_IMG_R.

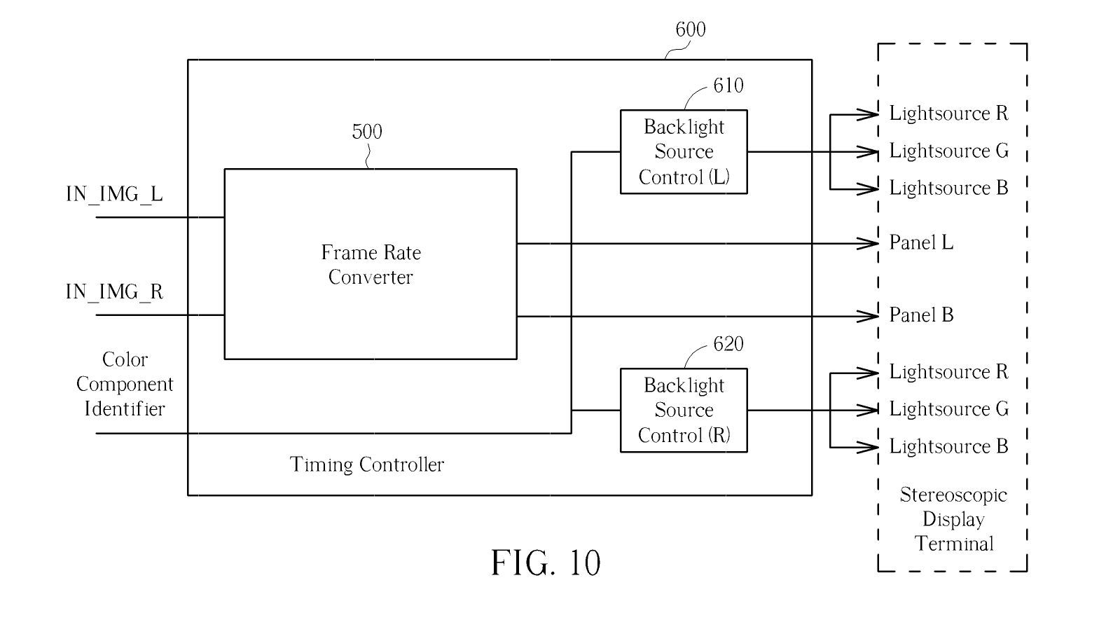

According to one exemplary embodiment, the present invention further provides a timing controller for a stereoscopic display, which includes the frame rate converter shown in FIG. 9. With reference to FIG. 10, a block diagram of a timing controller is illustrated. The timing controller 600 includes a backlight source controlling circuit (L) 610, a backlight source controlling circuit (R) 620 and a frame rate converter 500 as explained above. The operations of the frame rate converter 500 have been thoroughly explained before, and more detailed descriptions are therefore omitted here for the sake of brevity. The backlight source controlling circuit (L) 610 is utilized for controlling operating timing of a plurality of backlight sources of a left panel L in the stereoscopic display in response to a plurality of color component identifiers while the backlight source controlling circuit (R) 620 is utilized for controlling operating timing of a plurality of backlight sources of a right panel R in the stereoscopic display in response to the color component identifiers. Similarly, the timing controller 600 can provides frames to a stereoscopic display with low frame delay.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), programmable logic devices (PLDs), field programmable gate arrays (FPGAs), processor, electronic devices, other electronic units designed to perform the functions described herein, or a combination thereof. For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit.

In conclusion, the present invention reduces the frame delay caused by the frame rate conversion in the conventional art. By rearranging the image data and utilizing a color-sequential display method, the frame rate can be improved without causing severe frame delay.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A frame rate converter, comprising
a receiving circuit, for receiving an input image data and accordingly outputting an output image data, the input image data having a plurality of data segments with information of a plurality of color components of pixels of a frame, respectively, wherein each of the data segments includes information of a same color component only;
a frame buffer, coupled to the receiving circuit for storing the output image data; and
a first multiplexer, coupled to the frame buffer and the receiving circuit, for selecting one of the output image data outputted from the receiving circuit and the output image data buffered in the frame buffer as an output of the frame rate converter;
wherein the first multiplexer outputs the output image data buffered in the frame buffer at least once after outputting the output image data outputted from the receiving circuit to generate at least one duplication of the frame.

2. The frame rate converter of claim 1, wherein information of a same color component of adjacent pixels in a same row of the frame is contiguously arranged in a same data segment.

3. The frame rate converter of claim 1, wherein the receiving circuit comprises:
a plurality of gamma conversion units, for respectively performing gamma conversions on the data segments; and
a second multiplexer, coupled to the gamma conversion units, operating in response to a plurality of color component identifiers respectively corresponding to the data segments, for multiplexing outputs of the gamma conversion units to generate the output image data.

4. A framer rate converter for stereoscopic display, comprising:
a receiving circuit, for receiving a left-view input image data and a right-view input image data, and accordingly outputting a left-view output image data and a right-view output image data, each of the left-view input image data and the right-view input image data comprising a plurality of data segments with information of a plurality of color components of pixels of an interleaved frame, respectively, wherein each of the data segments includes information of a same color component only; and
a buffer module, comprising:
a first frame buffer, coupled to the receiving circuit, for storing the left-view output image data; and
a second frame buffer, coupled to the receiving circuit, for storing the right-view output image data;
wherein the first frame buffer outputs the left-view output image data buffered therein more than once, and the second frame buffer outputs the right-view output image data buffered therein more than once to generate at least one duplication of each interleaved frame.

5. The frame rate converter of claim 4, wherein information of a same color component of adjacent pixels corresponding to a same interleaved frame is contiguously arranged in a same data segment.

6. The frame rate converter of claim 4, wherein the receiving circuit comprises:
a plurality of gamma conversion units, for respectively performing gamma conversions on the data segments of each of the left-view input image data and the right-view input image data; and
a multiplexer, coupled to the gamma conversion units, operating in response to a plurality of color component identifiers respectively corresponding to each data segment, for multiplexing outputs of the gamma conversion units to generate each of the first output image data and the second output image data.

7. A timing controller, comprising:
a receiving circuit, for receiving an input image data and accordingly outputting an output image data, the input image data having a plurality of data segments with information of a plurality of color components of pixels of a frame, respectively, wherein each of the data segments includes information of a same color component only;
a frame buffer, coupled to the receiving circuit for storing the output image data;
a first multiplexer, coupled to the frame buffer and the receiving circuit, for selecting one of the output image data outputted from the receiving circuit and the output image data buffered in the frame buffer as an output of the frame rate converter; and
a backlight source controlling circuit, for controlling operating timing of a plurality of backlight sources in response to a plurality of color component identifiers respectively corresponding to each data segment;
wherein the first multiplexer outputs the output image data buffered in the frame buffer at least once after outputting the output image data outputted from the receiving circuit to generate at least one duplication of the frame.

8. The timing controller of claim 7, wherein information of a same color component of adjacent pixels in a same row of the frame is contiguously arranged in a same data segment.

9. The timing controller of claim 7, wherein the receiving circuit comprises:
a plurality of gamma conversion units, for respectively performing gamma conversions on the data segments; and
a second multiplexer, coupled to the gamma conversion units, operating in response to the plurality of color component identifiers respectively corresponding to each data segment, for multiplexing outputs of the gamma conversion units to generate the output image data.

10. A timing controller for stereoscopic displaying, comprising:
a receiving circuit, for receiving a left-view input image data and a right-view input image data, and outputting a left-view output image data and a right-view output image data, each of the left-view input image data and the right-view input image data comprising a plurality of data segments with information of a plurality of color components of pixels of an interleaved frame, respectively, wherein each of the data segments includes information of a same color component only;
a buffer module, comprising:
a first frame buffer, coupled to the receiving circuit, for storing the left-view output image data; and
a second frame buffer, coupled to the receiving circuit, for storing the right-view output image data; and
a backlight source controlling circuit, for controlling operating timing of a plurality of backlight sources in response to a plurality of color component identifiers respectively corresponding to each data segment;
wherein the first frame buffer outputs the left-view output image data buffered therein more than once, and the second frame buffer outputs the right-view output image data buffered therein more than once to generate at least one duplication of each interleaved frame.

11. The timing controller of claim 10, wherein information of a same color component of adjacent pixels corresponding to a same interleaved frame is contiguously arranged in a same data segment.

12. The timing controller of claim 10, wherein the receiving circuit comprises:
a plurality of gamma conversion units, for respectively performing gamma conversions on the data segments; and
a multiplexer, coupled to the gamma conversion units, operating in response to the plurality of color component identifiers respectively corresponding to each data segment, for multiplexing outputs of the gamma conversion units to the left-view output image data and the right-view output image data.

13. A method of rearranging image data, comprising:
successively receiving data of a plurality of pixels of a frame, wherein data of each of the pixels includes information of a plurality color components; and
rearranging the data of each of the pixels of the frame to generate a plurality of data segments, wherein the data segments include information of the color components of the pixels, respectively, and each of the data segments includes information of a same color component only.

14. The method of claim 13, wherein information of a same color component of adjacent pixels in a same row of the frame is contiguously arranged in a same data segment.

15. The method of claim 13, wherein each of the data segments includes information of the same color component of all the pixels.

16. A processing apparatus of rearranging image data, comprising:
a receiving unit, for successively receiving data of a plurality of pixels of a frame, wherein data of each of the pixels includes information of a plurality color components; and
a rearranging unit, for rearranging the data of each of the pixels of the frame to generate a plurality of data segments, wherein the data segments include information of the color components of the pixels, respectively, and each of the data segments includes information of a same color component only.

17. The processing apparatus of claim 16, wherein information of a same color component of adjacent pixels in a same row of the frame is contiguously arranged in a same data segment.

18. The processing apparatus of claim 16, wherein each of the data segments includes information of the same color component of all the pixels.
